(19) United States
(12) Patent Application Publication
(10) Pub. No.: US 2026/0342015 A1
(43) Pub. Date: Oct. 29, 2026

(54) Connector and Mating Connector

(71) Applicants: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(72) Inventors: Hongjian (Neil) Ni, Shanghai (CN); Michael Streckewald, Middletown, PA (US); Yongfeng Li, Dongguan (CN); Qiaoli (Cherie) Chen, Shanghai (CN); Randall Robert Henry, Middletown, PA (US); David (Xinjie) Zhang, Shanghai (CN); Leo (Lizhou) Li, Shanghai (CN); Tim (Zhaohai) Xue, Shanghai (CN)

(73) Assignees: Tyco Electronics (Dongguan) Ltd., Dongguan City (CN); TE Connectivity Solutions GmbH, Schaffhausen (CH); Tyco Electronics (Shanghai) Co., Ltd., Shanghai (CN)

(21) Appl. No.: 19/532,744

(22) Filed: Feb. 6, 2026

(30) Foreign Application Priority Data
Feb. 8, 2025 (CN) 202510140118.2

(51) Int. Cl. H01R 13/648; H01R 12/71; H01R 13/6581

(52) U.S. Cl. CPC H01R 13/6485; H01R 12/716; H01R 13/6581

(57) ABSTRACT

A connector includes an insulation shell having a peripheral wall and a bottom wall enclosing an inner cavity. A retaining body is disposed in the inner cavity and connected to the bottom wall; the retaining body is in a middle region of the insulation shell and the insulation shell has a left region and a right region on sides of the retaining body. The connector includes a plurality of low-speed signal terminals respectively fixed to a front side and a rear side of the retaining body to electrically contact a plurality of low-speed mating signal terminals of a mating connector. The connector includes a plurality of terminal modules installed in the insulation shell and each including a plurality of pairs of high-speed signal terminals. One of the terminal modules is installed in the left region and another of the terminal modules is installed in the right region.

### CROSS-REFERENCE TO RELATED APPLICATION

This application claims the benefit of the filing date under 35 U.S.C. § 119(a)-(d) of Chinese Patent Application No. 202510140118.2, filed on Feb. 8, 2025.

### FIELD OF THE INVENTION

The present invention relates to a connector and a mating connector for mating with the connector.

### BACKGROUND OF THE INVENTION

In existing technology, wire end connectors typically include a housing, a circuit board located within the housing, and multiple cables electrically connected to the circuit board. The board end connector that matches with the wire end connector commonly includes an insulation shell and terminals set in the insulation shell. The terminals have contact spring arms that make electrical contact with the circuit board and soldering pins for soldering to the circuit board. The existing wire end connectors and board end connectors have high contact impedance and severe crosstalk, which cannot meet the requirements of higher speed signal transmission.

### SUMMARY OF THE INVENTION

A connector includes an insulation shell having a peripheral wall and a bottom wall enclosing an inner cavity. A retaining body is disposed in the inner cavity and connected to the bottom wall; the retaining body is in a middle region of the insulation shell and the insulation shell has a left region and a right region on sides of the retaining body. The connector includes a plurality of low-speed signal terminals respectively fixed to a front side and a rear side of the retaining body to electrically contact a plurality of low-speed mating signal terminals of a mating connector. The connector includes a plurality of terminal modules installed in the insulation shell and each including a plurality of pairs of high-speed signal terminals. One of the terminal modules is installed in the left region and another of the terminal modules is installed in the right region.

### BRIEF DESCRIPTION OF THE DRAWINGS

Features of the present invention will become more apparent by describing in detail exemplary embodiments thereof with reference to the accompanying drawings, in which:

FIG. 1 shows a three-dimensional schematic diagram of a connector according to an exemplary embodiment of the present invention;

FIG. 2 shows an exploded schematic diagram of a connector according to an exemplary embodiment of the present invention, without a display screen cover;

FIG. 3 shows a three-dimensional schematic diagram of a terminal module of a connector according to an exemplary embodiment of the present invention;

FIG. 4 shows a schematic plan view of the terminal module of a connector according to an exemplary embodiment of the present invention when viewed from one end;

FIG. 5 shows an exploded schematic diagram of the terminal module of a connector according to an exemplary embodiment of the present invention;

FIG. 6 shows an exploded schematic diagram of the grounding element and reinforcement strip of the terminal module of the connector according to an exemplary embodiment of the present invention;

FIG. 7 shows a transverse sectional view of a terminal module of a connector according to an exemplary embodiment of the present invention;

FIG. 8 shows a transverse exploded sectional view of a terminal module of a connector according to an exemplary embodiment of the present invention;

FIG. 9 shows a longitudinal sectional view of a terminal module of a connector according to an exemplary embodiment of the present invention;

FIG. 10 shows a longitudinal exploded sectional view of a terminal module of a connector according to an exemplary embodiment of the present invention;

FIG. 11 shows a three-dimensional schematic diagram of a connector and a mating connector according to an exemplary embodiment of the present invention;

FIG. 12 shows a perspective sectional view of a connector and a mating connector according to an exemplary embodiment of the present invention;

FIG. 13 shows a plan sectional view of a connector and a mating connector according to an exemplary embodiment of the present invention;

FIG. 14 shows a plan sectional view of a connector and a mating connector according to an exemplary embodiment of the present invention, where the high-speed signal terminal has just made electrical contact with the high-speed mating signal terminal and the grounding spring has not yet made electrical contact with the conductive shield;

FIG. 15 shows a plan sectional view of a connector and a mating connector according to an exemplary embodiment of the present invention, wherein the connector and the mating connector have been mated together;

FIG. 16 shows a three-dimensional schematic diagram of the high-speed signal terminal and low-speed signal terminal of a connector according to an exemplary embodiment of the present invention;

FIG. 17 shows a schematic plan view of the high-speed signal terminal and low-speed signal terminal of a connector according to an exemplary embodiment of the present invention;

FIG. 18 shows a schematic plan view of the high-speed signal terminal and low-speed signal terminal of a connector according to an exemplary embodiment of the present invention, as well as the high-speed matching signal terminal and low-speed matching signal terminal of a mating connector, the first low-speed signal terminal and the first low-speed matching signal terminal used for electrostatic discharge protection have just made contact, while the signal terminals for other functions have not yet made electrical contact;

FIG. 19 shows a perspective view of a connector and a mating connector according to an exemplary embodiment of the present invention when viewed from the front side;

FIG. 20 shows a three-dimensional schematic diagram of a connector and a mating connector according to an exemplary embodiment of the present invention when viewed from the rear side;

FIG. 21 shows an exploded schematic diagram of a mating connector according to an exemplary embodiment of the present invention;

FIG. 22 shows a three-dimensional schematic diagram of the mating terminal module and low-speed signal terminal module of a mating connector according to an exemplary embodiment of the present invention;

FIG. 23 shows an exploded schematic diagram of the mating terminal module of a mating connector according to an exemplary embodiment of the present invention;

FIG. 24 shows a three-dimensional schematic diagram of the mating terminal module of the mating connector according to an exemplary embodiment of the present invention when viewed from the back; and

FIG. 25 shows a three-dimensional schematic diagram of the mating terminal module of a mating connector according to an exemplary embodiment of the present invention when viewed from the back, where one shielding connector has not yet been soldered to the shielding layer of a row of high-speed signal cables.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

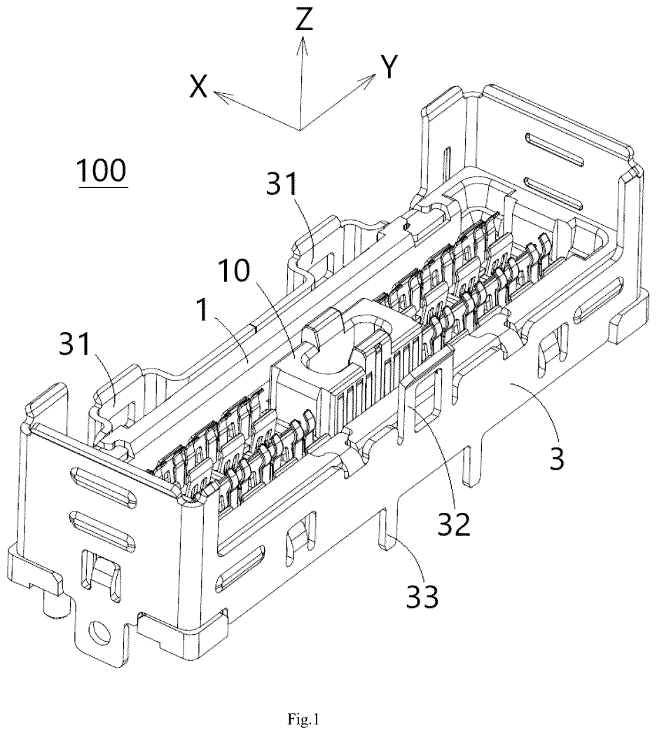

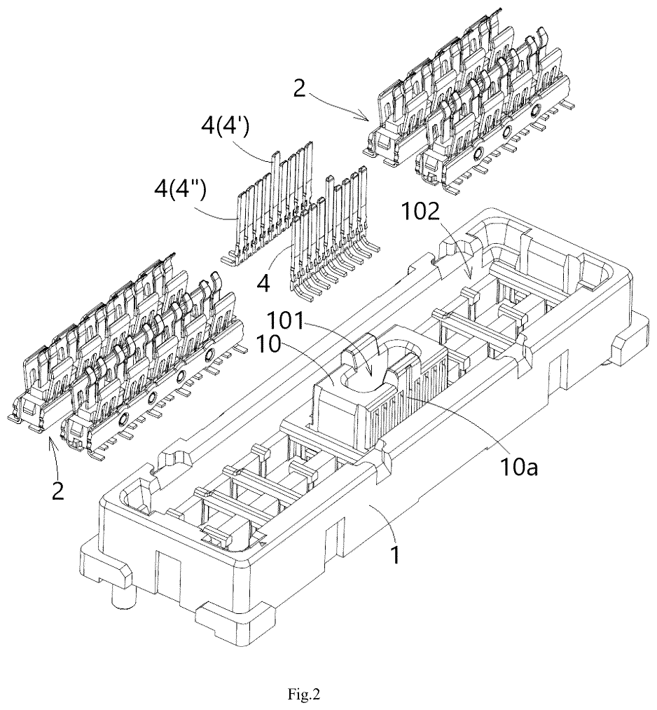

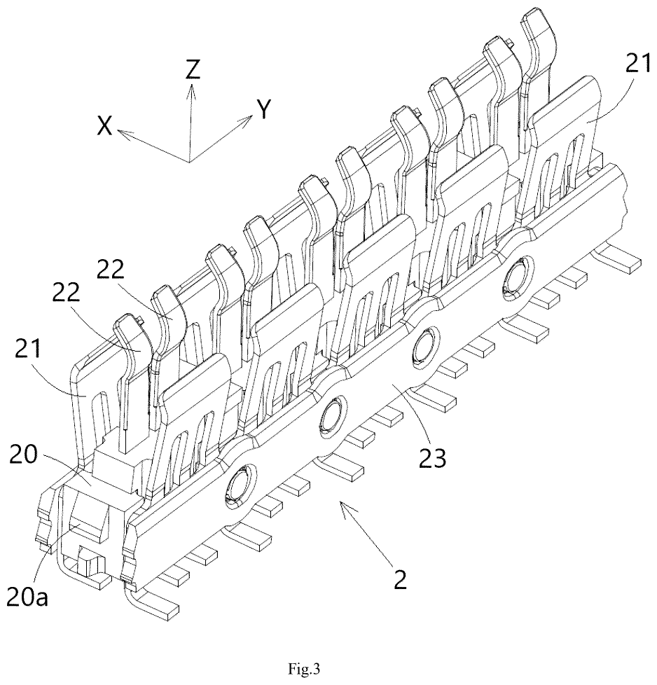

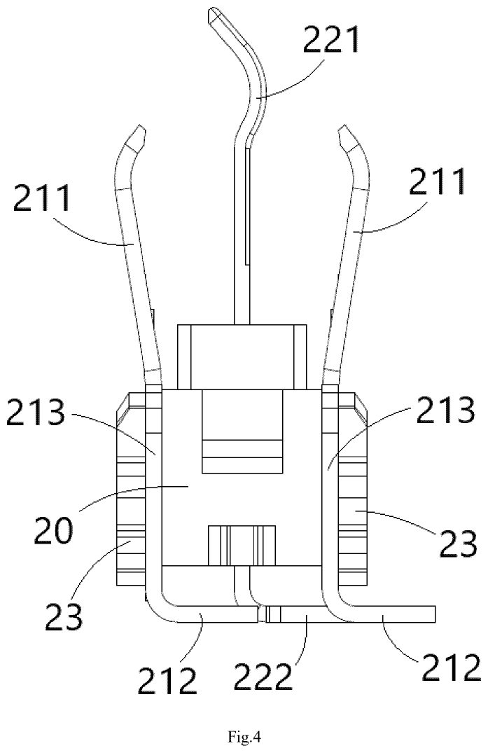

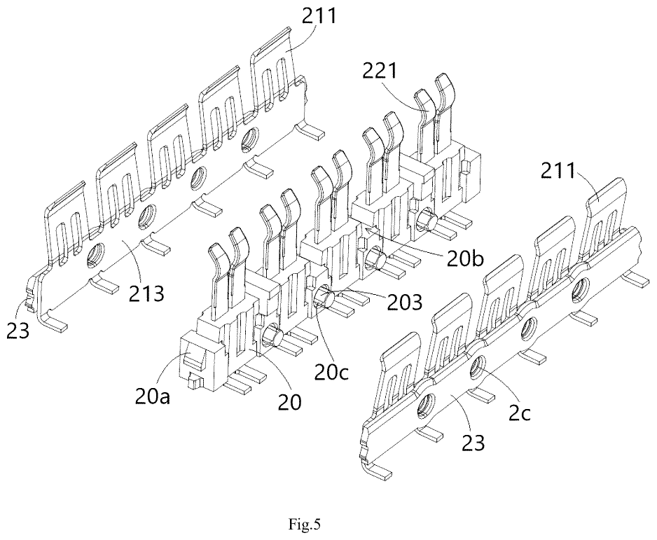

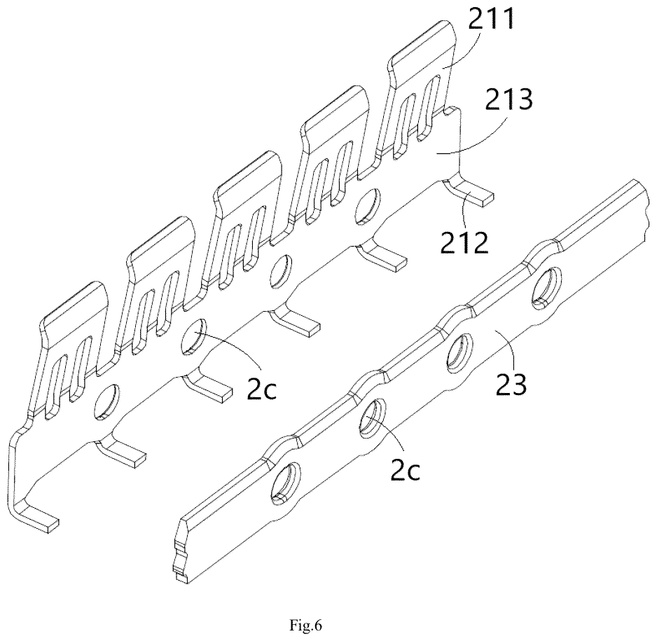

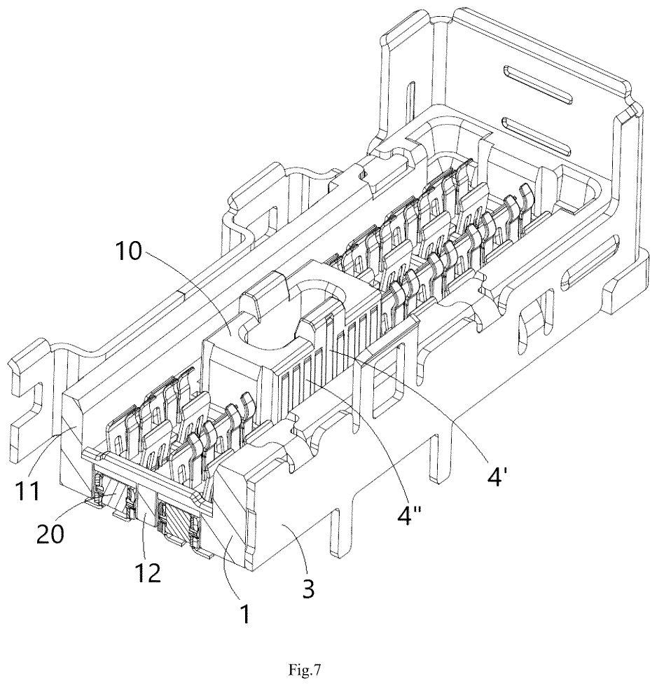

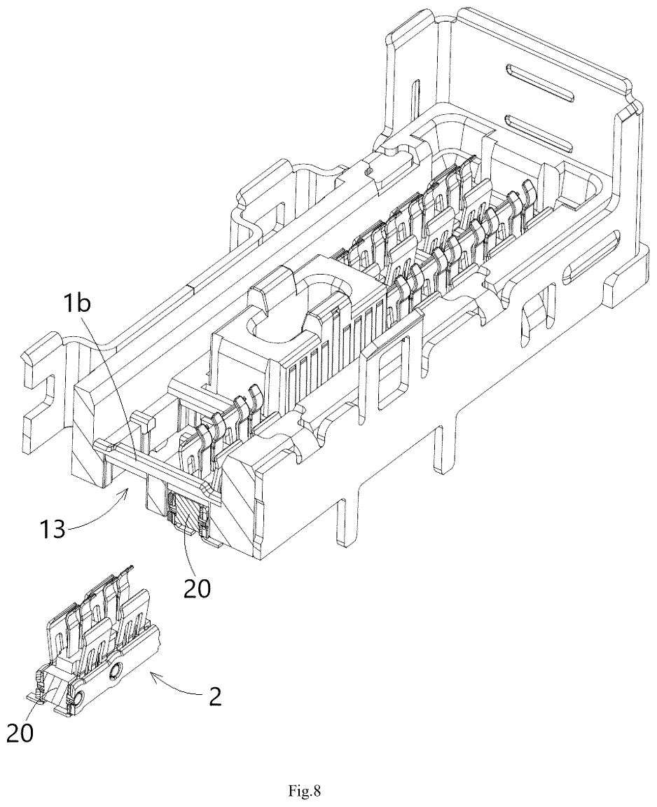

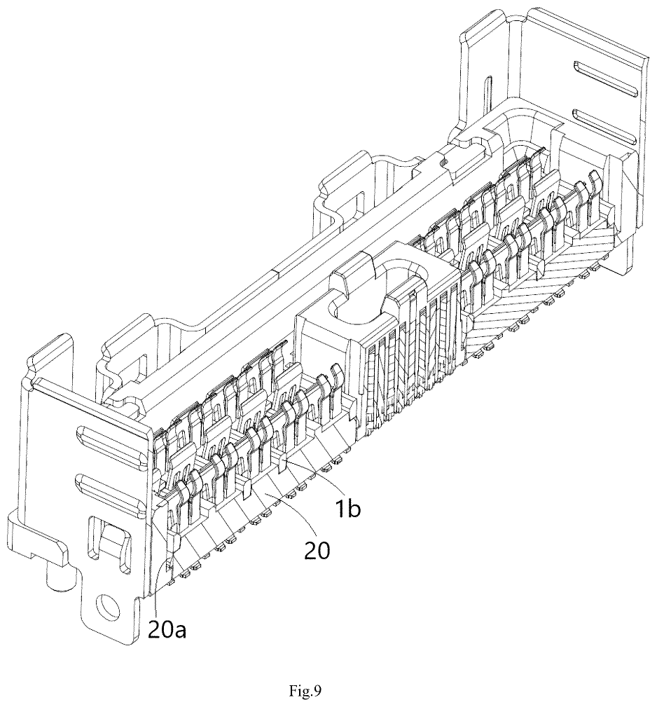

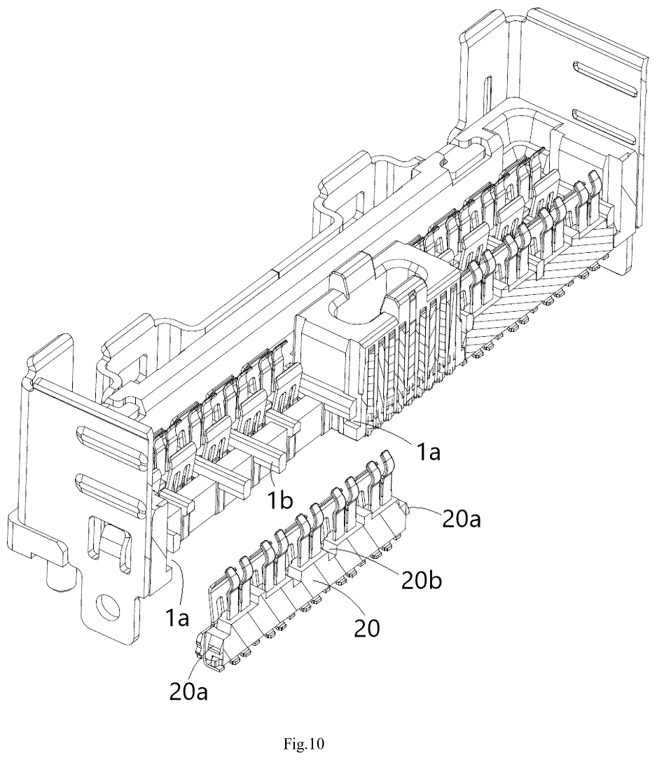

FIG. 1 shows a three-dimensional schematic diagram of a connector 100 according to an exemplary embodiment of the present invention; FIG. 2 shows an exploded schematic diagram of connector 100 according to an exemplary embodiment of the present invention, without display screen cover 3; FIG. 3 shows a three-dimensional schematic diagram of terminal module 2 of connector 100 according to an exemplary embodiment of the present invention; FIG. 4 shows a schematic plan view of terminal module 2 of connector 100, as viewed from one end, according to an exemplary embodiment of the present invention; FIG. 5 shows an exploded schematic diagram of terminal module 2 of connector 100 according to an exemplary embodiment of the present invention; FIG. 6 shows an exploded schematic diagram of the grounding element 21 and reinforcement strip 23 of the terminal module 2 of the connector 100 according to an exemplary embodiment of the present invention; FIG. 7 shows a transverse cross-sectional view of terminal module 2 of connector 100 according to an exemplary embodiment of the present invention; FIG. 8 shows a transverse exploded sectional view of terminal module 2 of connector 100 according to an exemplary embodiment of the present invention; FIG. 9 shows a longitudinal sectional view of terminal module 2 of connector 100 according to an exemplary embodiment of the present invention; FIG. 10 shows a longitudinal exploded sectional view of terminal module 2 of connector 100 according to an exemplary embodiment of the present invention.

As shown in FIGS. 1 to 10, in an exemplary embodiment of the present invention, a connector 100 is disclosed. The connector 100 includes an insulation shell 1, multiple low-speed signal terminals 4, and multiple terminal modules 2. The insulation shell 1 includes a peripheral wall 11 and a bottom wall 12 surrounding the inner cavity 102, as well as a retaining body 10 located in the inner cavity 102 and connected to the bottom wall 12. Multiple low-speed signal terminals 4 are respectively fixed to the front and rear sides of the holding body 10 for electrical contact with the low-speed mating signal terminal 7 of the mating connector 200. Multiple terminal modules 2 are installed into the insulation shell 1 and each includes multiple pairs of high-speed signal terminals (i.e., high-speed differential signal terminal pairs) 22. The retaining body 10 is located in the middle region of the insulating shell 1, which has left and right regions located on the left and right sides of the retaining body 10, respectively. Multiple terminal modules 2 are installed in the left and right regions of the insulating shell 1, respectively.

As shown in FIG. 2, in the illustrated embodiment, a positioning hole 101 is formed in the retaining body 10 of the insulating shell 1. The positioning hole 101 is used to mate with the positioning column 501 on the mating housing 5 of the mating connector 200 to guide the connector 100 to mate with the mating connector 200.

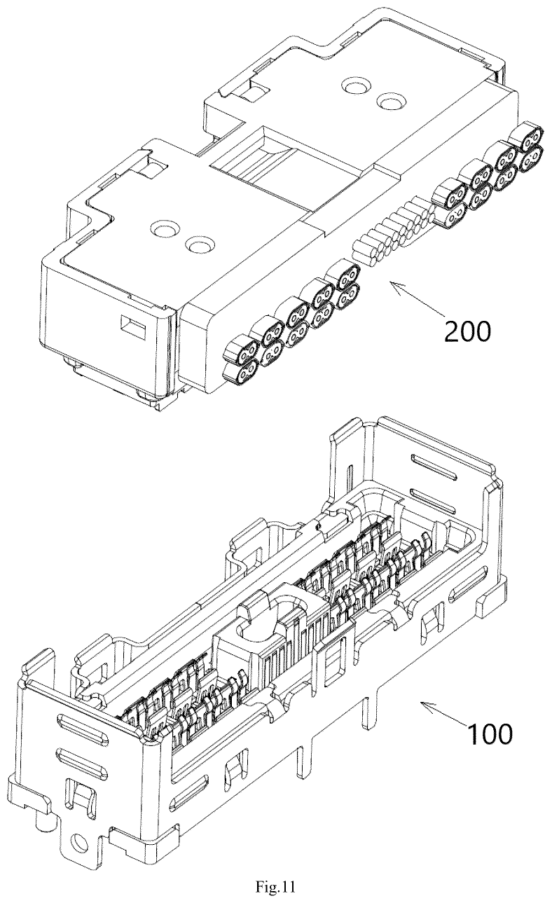

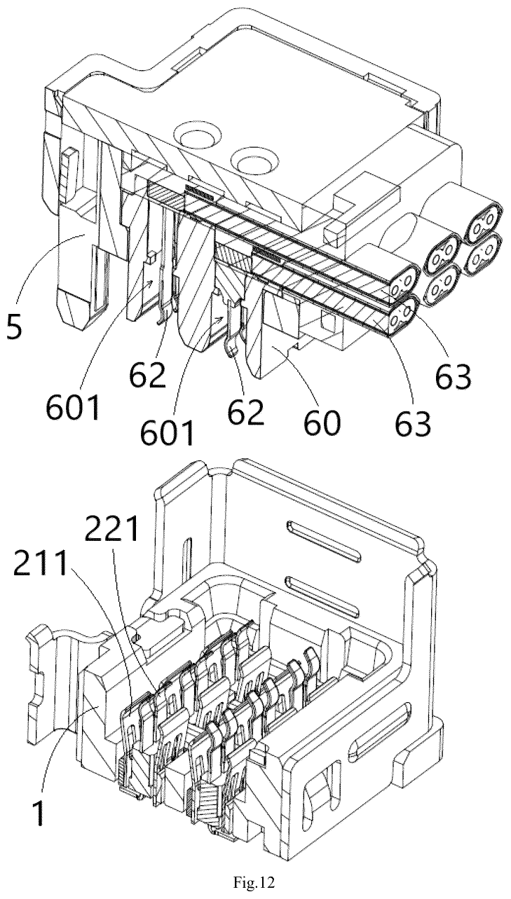

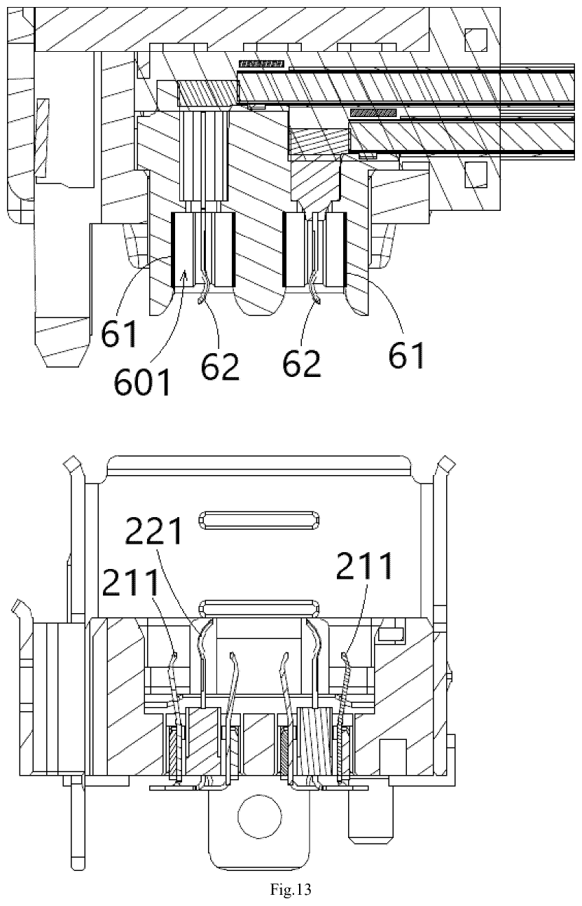

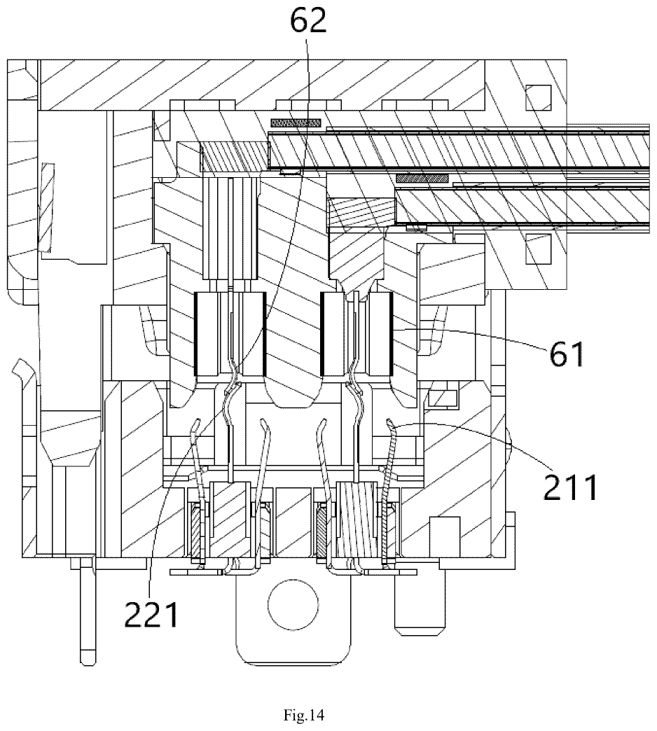

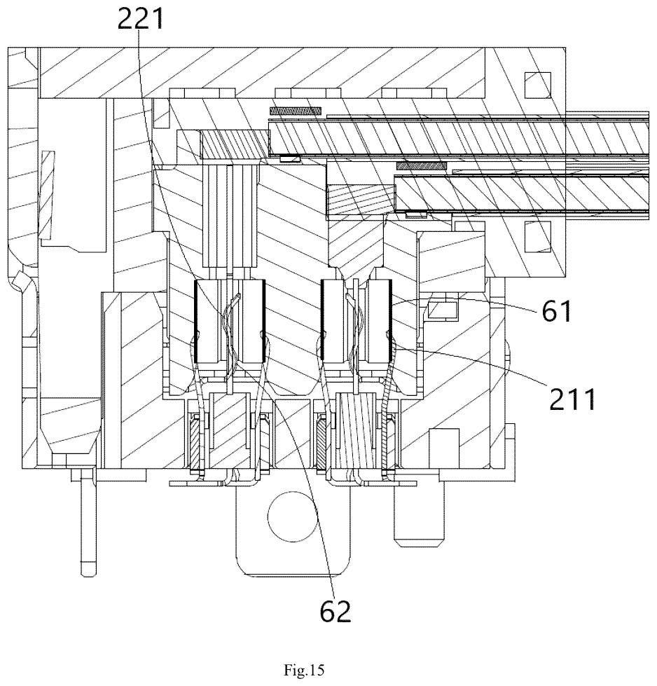

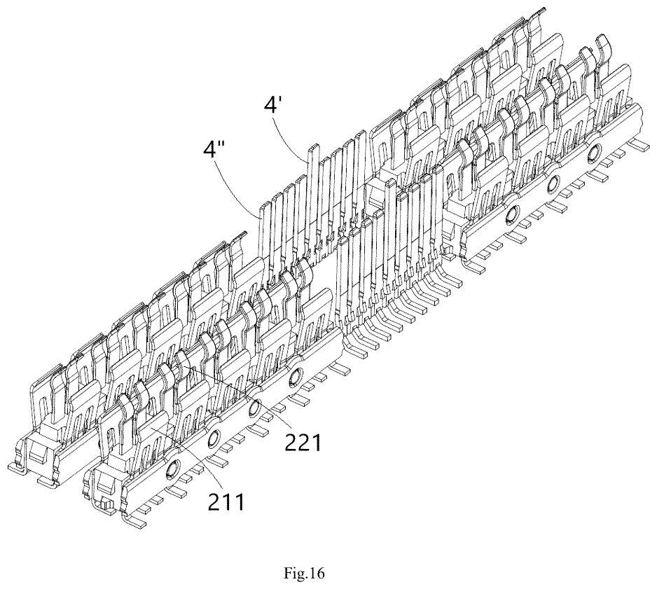

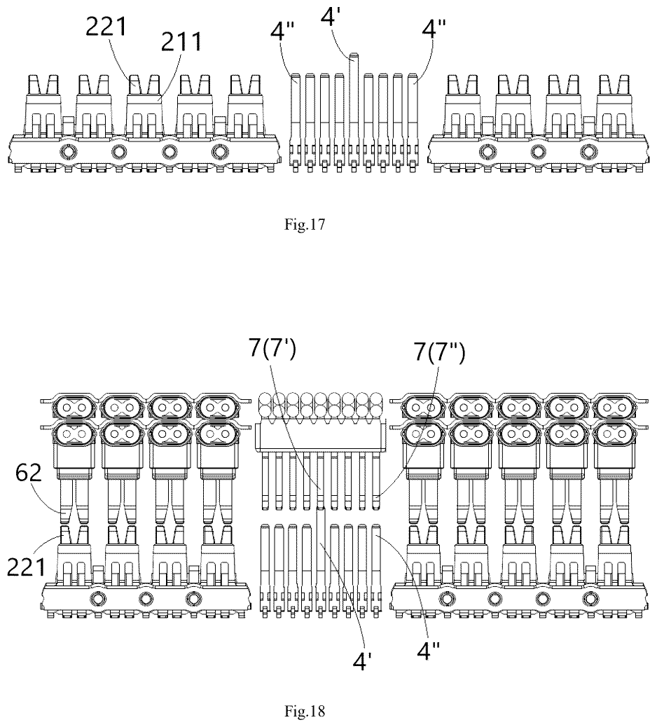

FIG. 11 shows a three-dimensional schematic diagram of connector 100 and mating connector 200 according to an exemplary embodiment of the present invention; FIG. 12 shows a perspective sectional view of connector 100 and mating connector 200 according to an exemplary embodiment of the present invention; FIG. 13 shows a plan sectional view of connector 100 and mating connector 200 according to an exemplary embodiment of the present invention; FIG. 14 shows a planar cross-sectional view of a connector 100 and a mating connector 200 according to an exemplary embodiment of the present invention, where the high-speed signal terminal 22 has just made electrical contact with the high-speed mating signal terminal 62, and the grounding spring 211 has not yet made electrical contact with the conductive shield 61; FIG. 15 shows a plan sectional view of connector 100 and mating connector 200 according to an exemplary embodiment of the present invention, where connector 100 and mating connector 200 have been mated together; FIG. 16 shows a three-dimensional schematic diagram of the high-speed signal terminal 22 and the low-speed signal terminal 4 of the connector 100 according to an exemplary embodiment of the present invention; FIG. 17 shows a schematic plan view of the high-speed signal terminal 22 and low-speed signal terminal 4 of connector 100 according to an exemplary embodiment of the present invention; FIG. 18 shows a schematic plan view of the high-speed signal terminal 22 and low-speed signal terminal 4 of connector 100, as well as the high-speed matching signal terminal 62 and low-speed matching signal terminal 7 of mating connector 200, according to an exemplary embodiment of the present invention. The first low-speed signal terminal 4′ and the first low-speed matching signal terminal 7′ for electrostatic discharge protection have just made contact, while the signal terminals for other functions have not yet made electrical contact.

As shown in FIGS. 2 and 7, in the illustrated embodiment, multiple low-speed signal terminals 4 include a first low-speed signal terminal 4′ for electrostatic discharge protection and a second low-speed signal terminal 4″ with a function different from the first low-speed signal terminal 4′. The extension length of the first low-speed signal terminal 4′ in the height direction Z of the insulation shell 1 is greater than that of the second low-speed signal terminal 4″. During the process of mating connector 100 with mating connector 200, the first low-speed signal terminal 4′ makes electrical contact with the first low-speed mating signal terminal 7′ of mating connector 200 before the second low-speed signal terminal 4″ makes electrical contact with the second low-speed mating signal terminal 7″ of mating connector 200.

In the illustrated embodiment, multiple low-speed signal terminals 4 are arranged in two rows and the two rows of low-speed signal terminals 4 are respectively fixed to the front and rear sides of the holding body 10. As shown in FIG. 2, multiple terminal slots 10a are formed on the front and rear sides of the holding body 10, and the low-speed signal terminal 4 is installed into the terminal slots 10a.

As shown in FIGS. 2 and 7, in the illustrated embodiment, each row of low-speed signal terminals 4 includes a first low-speed signal terminal 4′ and multiple second low-speed signal terminals 4″, and multiple second low-speed signal terminals 4″ are symmetrically arranged on the left and right sides of a first low-speed signal terminal 4′.

As shown in FIG. 3, in the illustrated embodiment, the terminal module 2 further comprises an insulator 20 and a pair of grounding members 21. A pair of grounding components 21 are fixed to the insulator 20 and spaced opposite each other in the width direction X of the insulator 20. Multiple pairs of high-speed signal terminals 22 are fixed to the insulator 20 and arranged in a row along the length direction Y of the insulator 20. One row of high-speed signal terminals 22 is located between a pair of grounding members 21 and is spaced apart from the grounding members 21 by a predetermined distance in the width direction X. The grounding component 21 includes multiple grounding spring pieces 211 corresponding to multiple pairs of high-speed signal terminals 22, and the multiple grounding spring pieces 211 are arranged in a row along the length direction Y of the insulator 20. The high-speed signal terminal 22 has a contact spring arm 221, and the contact spring arm 221 of each pair of high-speed signal terminals 22 is located between a pair of ground spring pieces 211 that are opposite in the width direction X.

As shown in FIGS. 3 and 4, in the illustrated embodiment, the grounding spring 211 of the grounding element 21 and the contact spring arm 221 of the high-speed signal terminal 22 extend upward from the top of the insulator 20, for electrical contact with the conductive shield 61 of the mating terminal module 6 of the mating connector 200 and the high-speed mating signal terminal 62, respectively. The length of the upward extension of the contact spring arm 221 is greater than that of the grounding spring 211, so that during the process of mating the connector 100 with the mating connector 200, the contact spring arm 221 makes electrical contact with the high-speed mating signal terminal 62 before the grounding spring 211 makes electrical contact with the conductive shield 61.

During the mating process between connector 100 and mating connector 200, the first low-speed signal terminal 4′ makes electrical contact with the first low-speed mating signal terminal 7′ before the high-speed signal terminal 22 makes electrical contact with the high-speed mating signal terminal 62 of mating connector 200.

In an embodiment, the insulator 20 is injection molded onto multiple pairs of high-speed signal terminals 22, so that the insulator 20 and the multiple pairs of high-speed signal terminals 22 become an integrated piece.

As shown in FIGS. 4 to 6, in the illustrated embodiment, the grounding member 21 also has a fixing strip 213 extending along the length direction Y of the insulator 20, and the insulator 20 has two opposite sides in its width direction X. A pair of fixing strips 213 of the grounding member 21 are respectively fixed to both sides of the insulator 20. The fixing strip 213 has upper and lower sides opposite to each other in the height direction Z of the insulator 20, and a row of grounding spring pieces 211 of the grounding member 21 is connected to the upper side of the fixing strip 213.

As shown in FIG. 4, in the illustrated embodiment, the grounding member 21 also has multiple grounding pins 212 located at the bottom of the insulator 20. The multiple grounding pins 212 are arranged in a row along the length direction Y of the insulator 20 and connected to the lower side edge of the fixing strip 213. The high-speed signal terminal 22 has high-speed signal solder pins 222 exposed from the bottom of the insulator 20, and the high-speed signal solder pins 222 and the ground solder pins 212 are suitable for surface mount soldering to a circuit board.

As shown in FIGS. 2 to 6, in the illustrated embodiment, the terminal module 2 of the connector 100 further includes a pair of reinforcing bars 23, which are respectively welded to the fixing bars 213 of the grounding member 21 to increase the strength of the fixing bars 213 of the grounding member 21. The inner side of the fixing strip 213 of the grounding element 21 is pressed against the insulator 20, and the reinforcing strip 23 is welded to the outer side of the fixing strip 213 of the grounding element 21.

As shown in FIG. 5, in the illustrated embodiment, multiple protruding pillars 203 are formed on both sides of the insulator 20, and the multiple protruding pillars 203 are arranged in a row along the length direction Y of the insulator 20. Multiple insertion holes 2c are respectively formed on the fixed strip 213 and the reinforcing strip 23, and multiple protruding posts 203 are engaged with multiple insertion holes 2c to fix the grounding member 21 to the insulator 20.

As shown in FIG. 5, in the illustrated embodiment, multiple convex ribs 20C are formed on the protruding column 203, which extend along the axial direction of the protruding column 203 and are distributed at intervals in the circumferential direction of the protruding column 203. The multiple protruding ribs 20C on the protruding column 203 are in interference fit with the hole wall of the insertion hole 2c to fix the protruding column 203 into the insertion hole 2c.

As shown in FIG. 8 in the illustrated embodiment, a mounting groove 13 extending along the length direction Y of the insulation shell 1 is formed on the bottom wall 12 of the insulation shell 1. The insulator 20 of the terminal module 2 is embedded in the mounting groove 13, and the contact spring arm 221 of the high-speed signal terminal 22 and the grounding spring 211 of the grounding piece 21 are located in the inner cavity 102 of the insulation shell 1.

As shown in FIG. 5, in the illustrated embodiment, the insulator 20 has two opposite ends in its length direction Y, and protrusions 20A are formed at each end of the insulator 20. As shown in FIG. 10, there are card slots 1a formed on the inner walls of both ends of the installation slot 13 of the insulation shell 1, and the card slots 1a are engaged with the protrusions 20A on the insulator 20 to lock the terminal module 2 in the insulation shell 1.

As shown in FIGS. 8 and 9, in the illustrated embodiment, a positioning rib 1b spanning the installation groove 13 is formed in the insulating shell 1, and a positioning groove 20b extending along its width direction X is formed at the top of the insulator 20. The positioning groove 20b is engaged with the positioning rib 1b to position the terminal module 2 in the insulating shell 1.

As shown in FIG. 3, in the illustrated embodiment, the grounding component 21 is an integral stamped part. Insulation shell 1 is an integrated injection molded part.

As shown in FIG. 1, in the illustrated embodiment, the connector 100 further includes a shielding shell 3. The shielding shell 3 is fitted onto the insulation shell 1 and has front and rear sides opposite to each other in the width direction X of the insulation shell 1. A front buckle 31 is formed on the front side of the shielding shell 3, which is used to engage with the elastic hook 81 on the locking piece 8 of the mating connector 200. A rear buckle 32 is formed on the rear side of the shielding shell 3, which is used to engage with the locking protrusion 52 on the mating housing 5 of the mating connector 200.

As shown in FIG. 1, in the illustrated embodiment, the shielding shell 3 has a soldering leg 33 located at the bottom of the insulating shell 1, which is used for insertion and soldering into the socket 2c on the circuit board. In the illustrated embodiment, the shielding shell 3 is an integral stamped part.

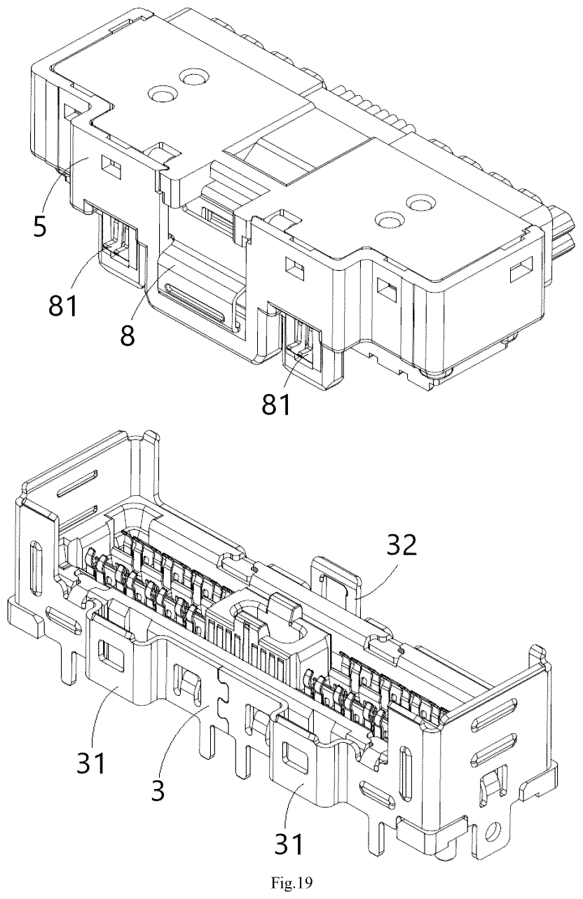

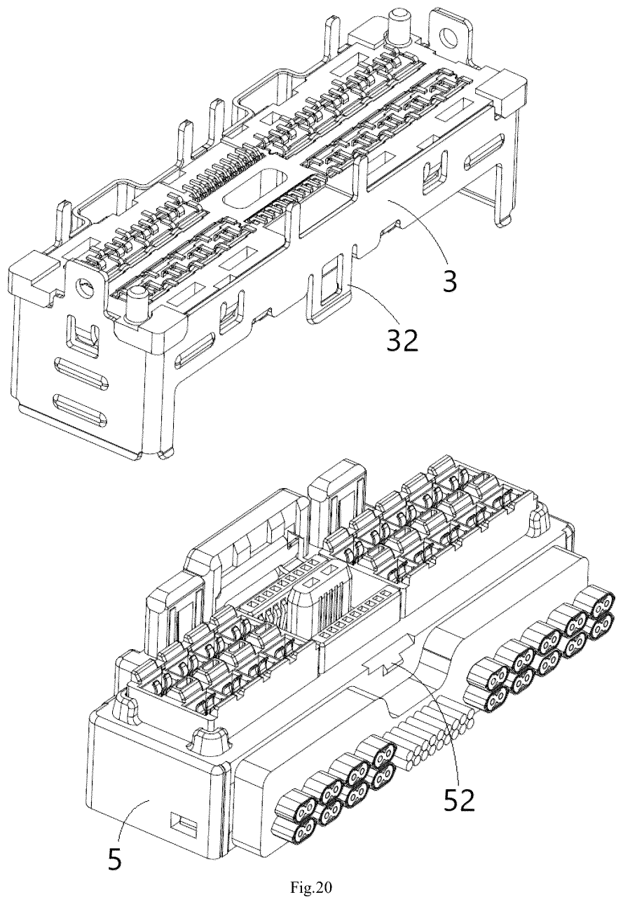

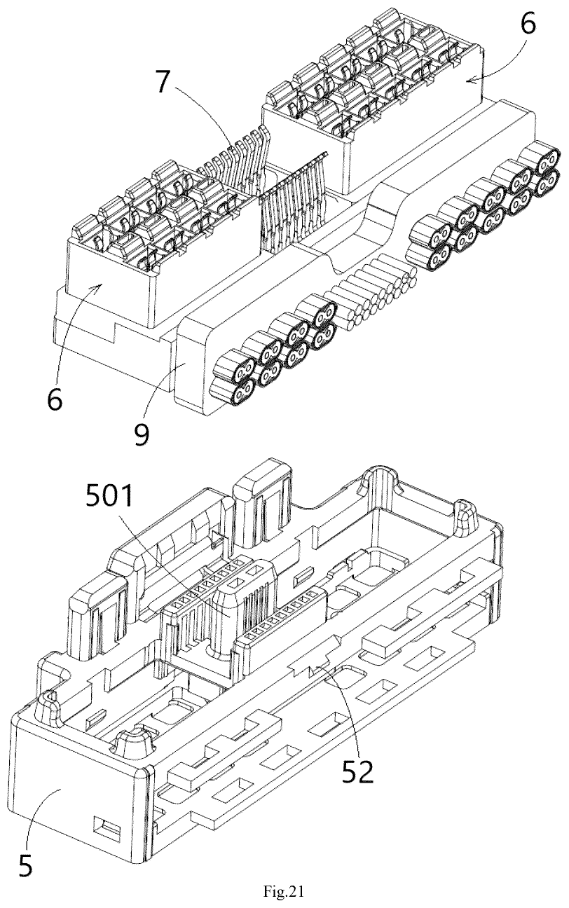

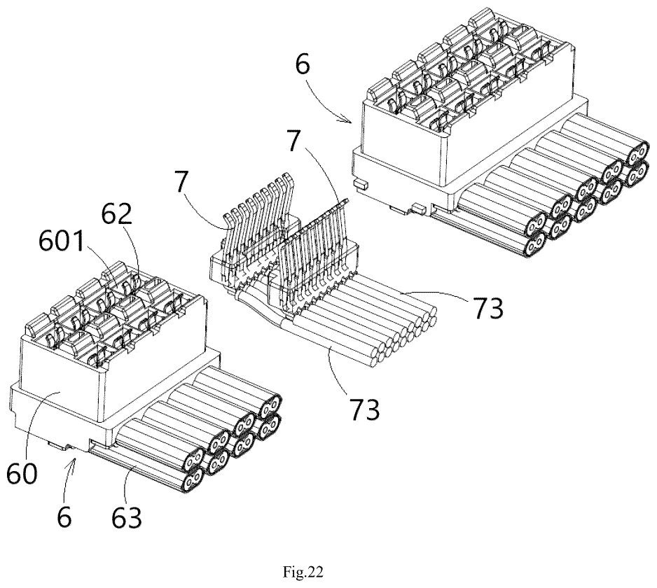

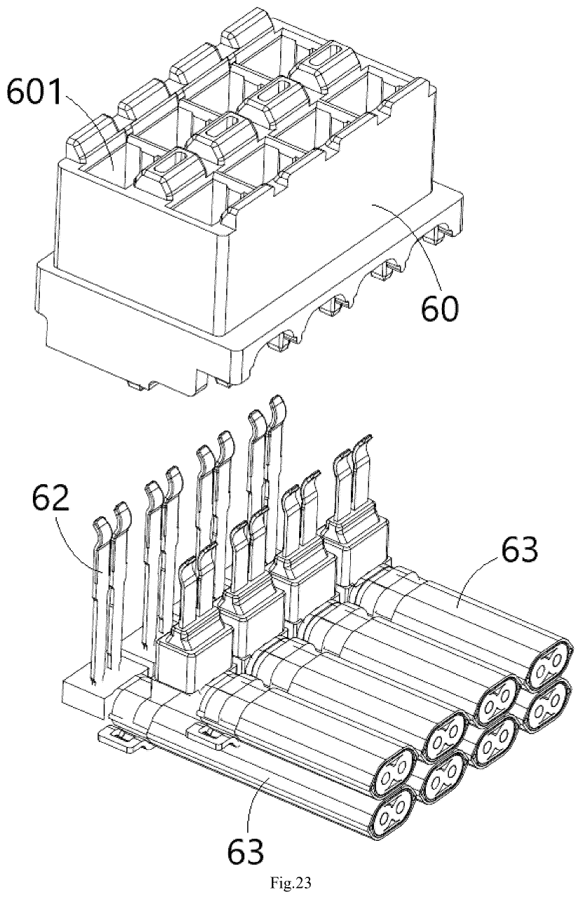

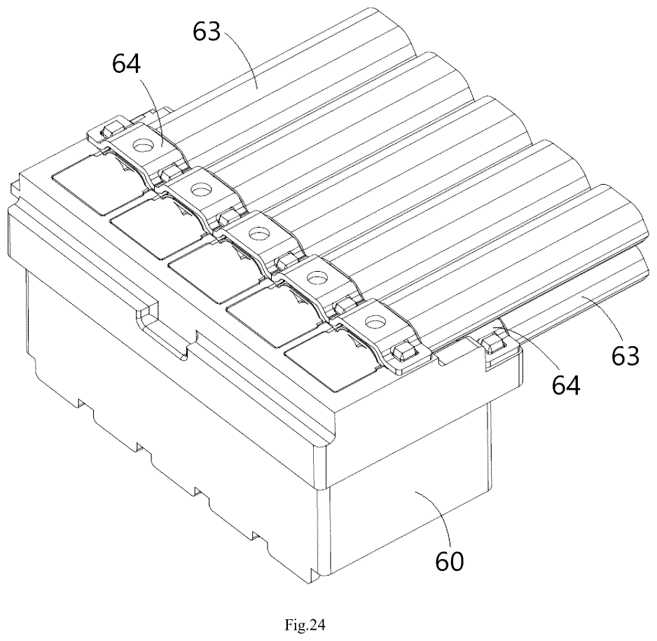

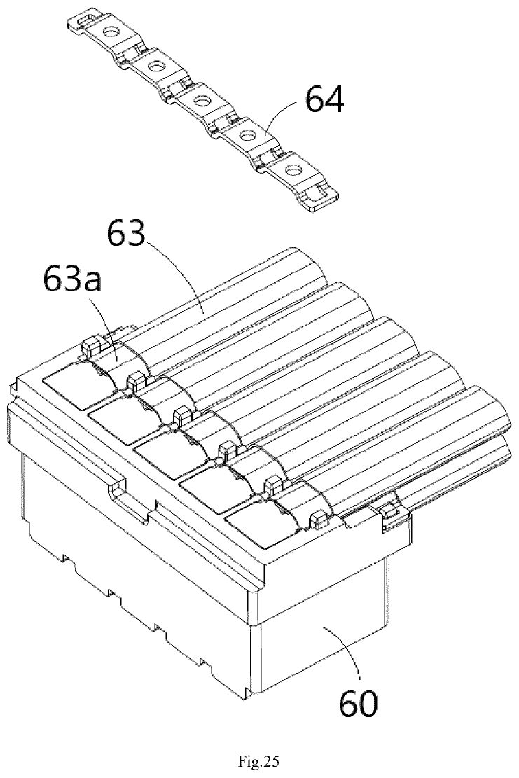

FIG. 19 shows a perspective view of connector 100 and mating connector 200 according to an exemplary embodiment of the present invention when viewed from the front side; FIG. 20 shows a three-dimensional schematic diagram of connector 100 and mating connector 200 according to an exemplary embodiment of the present invention when viewed from the rear; FIG. 21 shows an exploded schematic diagram of a mating connector 200 according to an exemplary embodiment of the present invention; FIG. 22 shows a three-dimensional schematic diagram of the mating terminal module 6 and low-speed signal terminal module of the mating connector 200 according to an exemplary embodiment of the present invention; FIG. 23 shows an exploded schematic diagram of the mating terminal module 6 of the mating connector 200 according to an exemplary embodiment of the present invention; FIG. 24 shows a three-dimensional schematic diagram of the mating terminal module 6 of the mating connector 200 according to an exemplary embodiment of the present invention when viewed from the back; FIG. 25 shows a three-dimensional schematic diagram of the mating terminal module 6 of the mating connector 200 according to an exemplary embodiment of the present invention when viewed from the back, where one shielding connector 64 has not yet been soldered to the shielding layer 12c of a row of high-speed signal cables 63.

As shown in FIG. 11, in another exemplary embodiment of the present invention, a mating connector 200 is also disclosed. The mating connector 200 includes a mating housing 5 and a mating terminal module 6, as shown in FIG. 12. The matching terminal module 6 is installed in the matching housing 5. Matching terminal module 6 includes: matching insulator 60, multiple pairs of high-speed matching signal terminals 62, and conductive shield 61. The mating insulator 60 has multiple slots 601. Multiple pairs of high-speed pairing signal terminals 62 are respectively set in multiple slots 601. Conductive shield 61 is set into slot 601. The mating connector 200 is used for mating with the aforementioned connector 100, the mating terminal module 6 is used for mating with the terminal module 2, the contact spring arm 221 of the high-speed signal terminal 22 is used for electrical contact with the high-speed mating signal terminal 62, and the grounding spring 211 of the grounding piece 21 is used for electrical contact with the conductive shield 61.

As shown in FIGS. 20 and 21, in the illustrated embodiment, the mating housing 5 includes an outer peripheral wall enclosing a receiving cavity and a positioning column 501 located in the receiving cavity and connected to the outer peripheral wall. The positioning column 501 is used to mate with the positioning hole 101 on the retaining body 10 of the connector 100 to guide the connector 100 to mate with the mating connector 200.

As shown in FIGS. 13 to 15, in the illustrated embodiment, the conductive shield 61 includes a conductive layer electroplated onto the inner wall surface of the slot 601 of the mating insulator 60. In another embodiment, the conductive shield 61 includes a conductive plate installed into the slot 601 of the mating insulator 60.

As shown in FIGS. 12 and 22 to 25, in the illustrated embodiment, the mating connector further includes multiple high-speed signal cables 63. Multiple high-speed signal cables 63 are electrically connected to multiple pairs of high-speed paired signal terminals 62. The shielding layer 63a of the high-speed signal cable 63 is electrically connected to the conductive shield 61.

As shown in FIG. 23, in the illustrated embodiment, multiple slots 601 on the mating insulator 60 are arranged in two rows, multiple pairs of high-speed mating signal terminals 62 are arranged in two rows, multiple high-speed signal cables 63 are arranged in two rows, and the mating terminal module 6 is used to mate with the two terminal modules 2 arranged side by side.

As shown in FIG. 22, in the illustrated embodiment, the mating connector 200 further includes two shielding connectors 64. Two shielding connectors 64 are respectively welded to the shielding layer 63a of two rows of high-speed signal cables 63 and welded to the conductive shield 61 to electrically connect the shielding layer 63a of the high-speed signal cable 63 to the conductive shield 61.

As shown in FIG. 22, in the illustrated embodiment, the mating connector 200 further includes multiple low-speed mating signal terminals 7. Multiple low-speed pairing signal terminals 7 are arranged in the pairing housing 5 for electrical contact with the multiple low-speed signal terminals 4 of the connector 100.

As shown in FIGS. 18 and 22, in the illustrated embodiment, multiple low-speed pairing signal terminals 7 are arranged in two rows. Each row of low-speed pairing signal terminals 7 includes: a first low-speed pairing signal terminal 7′ and a second low-speed pairing signal terminal 7″. The first low-speed pairing signal terminal 7′ is used for electrostatic discharge protection and is suitable for electrical contact with the first low-speed signal terminal 4′ of connector 100. The second low-speed pairing signal terminal 7′ has a different function from the first low-speed pairing signal terminal 7′ and is suitable for electrical contact with the second low-speed signal terminal 4″ of connector 100.

As shown in FIG. 22, in the illustrated embodiment, the mating connector 200 further includes multiple low-speed signal cables 73, which are respectively electrically connected to multiple low-speed mating signal terminals 7.

As shown in FIG. 21, in the illustrated embodiment, the mating connector 200 further includes a cable retaining body 9. The cable holder 9 is injection molded onto multiple low-speed signal cables 73 and multiple high-speed signal cables 63 of the mating connector 200.

As shown in FIG. 19, in the illustrated embodiment, the mating connector 200 further includes a locking component 8. The locking component 8 is installed onto the mating housing 5 and has an elastic hook 81. The elastic hook 81 is located on the front side of the mating housing 5 and is used to engage with the front buckle 31 on the front side of the shielding housing 3 of the connector 100. A locking protrusion 52 is formed on the rear side of the mating housing 5, which is used to engage with the rear buckle 32 on the rear side of the shielding shell 3 of the connector 100. The elastic hook 81 is adapted to move between a locked position engaged with the front buckle 31 and an unlocked position separated from the front buckle 31. The mating connector 200 also includes an unlocking strap, which is connected to the locking element 8 and used to drive the elastic hook 81 to move between the locking position and the unlocking position.

In the aforementioned exemplary embodiments according to the present invention, one row of high-speed signal terminals in the terminal module is located between two rows of grounding springs, and the contacts of the grounding springs are not in the same row as the contacts of the high-speed signal terminals. Therefore, the present invention can effectively suppress resonance and noise coupling between adjacent pairs of high-speed signal terminals, reducing signal crosstalk.

In the aforementioned exemplary embodiments according to the present invention, the two rows of grounding springs in the terminal module are in electrical contact with the conductive shielding in the mating insulator of the mating terminal module, thereby forming a grounding circuit and improving the electromagnetic shielding effect of the connector product. In addition, the conductive shielding in the paired insulator can effectively suppress the noise coupling between adjacent pairs of high-speed signal terminals and reduce signal crosstalk.

In the aforementioned exemplary embodiments according to the present invention, the low-speed signal terminals are arranged in the middle area of the connector, and the high-speed signal terminals are respectively arranged on the left and right sides of the middle area of the connector. This layout can optimize the impedance consistency of the signal transmission path and meet the requirements of higher signal transmission rate and lower fitting height.

In the aforementioned exemplary embodiments according to the present invention, the connector and the mating connector are matched with positioning posts and positioning holes to ensure smooth mating between the connector and the mating connector. In addition, the front and rear sides of the shielding shell of the connector are respectively formed with front and rear buckles that engage with the mating connector, which can reliably lock the connector and the mating connector together.

In the aforementioned exemplary embodiments according to the present invention, the extension length of the contact spring arm of the high-speed signal terminal of the connector is greater than the extension length of the grounding spring. Therefore, the contact spring arm makes electrical contact with the high-speed mating signal terminal before the grounding spring contacts the conductive shield, thereby reducing the mating force between the connector and the mating connector during mating.

In the aforementioned exemplary embodiments according to the present invention, the extension length of the electrostatic discharge protection terminal in the low-speed signal terminal of the connector is greater than that of the signal terminals of other functions. Therefore, the electrostatic discharge protection terminal can make electrical contact with the mating signal terminal before the signal terminals of other functions, providing effective electrostatic discharge protection for the connector product and improving its safety during use.

In the aforementioned exemplary embodiments according to the present invention, a reinforcing strip is welded to the fixing strip of the grounding member, thereby improving the strength of the grounding member without increasing the thickness of the grounding spring. Thinner grounding spring can improve the signal integrity of the connector product and reduce the insertion and extraction force.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector comprising:
an insulation shell including a peripheral wall and a bottom wall enclosing an inner cavity, a retaining body is disposed in the inner cavity and connected to the bottom wall, the retaining body is in a middle region of the insulation shell and the insulation shell has a left region and a right region on a left side and a right side respectively of the retaining body;
a plurality of low-speed signal terminals respectively fixed to a front side and a rear side of the retaining body to electrically contact a plurality of low-speed mating signal terminals of a mating connector; and
a plurality of terminal modules installed in the insulation shell and each including a plurality of pairs of high-speed signal terminals, one of the terminal modules is installed in the left region and another of the terminal modules is installed in the right region.

2. The connector according to claim 1, wherein the retaining body has a positioning hole cooperating with a positioning column on a mating housing of the mating connector to guide the connector to mate with the mating connector.

3. The connector according to claim 1, wherein the low-speed signal terminals include a first low-speed signal terminal for electrostatic discharge protection and a second low-speed signal terminal with a function different from the first low-speed signal terminal, an extension length of the first low-speed signal terminal in a height direction of the insulation shell is greater than an extension length of the second low-speed signal terminal, and during mating of the connector with the mating connector, the first low-speed signal terminal makes electrical contact with a first low-speed mating signal terminal of the mating connector before the second low-speed signal terminal makes electrical contact with a second low-speed mating signal terminal of the mating connector.

4. The connector according to claim 3, wherein a plurality of terminal slots are formed on the front side and the rear side of the retaining body, the low-speed signal terminals are installed in the terminal slots in a pair of rows.

5. The connector according to claim 4, wherein each row of low-speed signal terminals includes one first low-speed signal terminal and a plurality of second low-speed signal terminals, the second low-speed signal terminals re symmetrically arranged on a pair of sides of the first low-speed signal terminal.

6. The connector according to claim 1, wherein a mounting groove extending along a length direction of the insulation shell is formed on the bottom wall, an insulator of one of the terminal modules is embedded in the mounting groove, a contact spring arm of the high-speed signal terminals and a grounding element of the one of the terminal modules is located in the inner cavity.

7. The connector according to claim 6, wherein the insulator has a pair of opposite ends in the length direction, a protrusion is formed at each of the pair of opposite ends of the insulator and engages with a slot in the insulation shell to lock the terminal module in the insulation shell.

8. The connector according to claim 6, wherein the insulation shell has a positioning rib spanning the mounting groove, a positioning groove formed in the insulator engages with the positioning rib to position the terminal module in the insulation shell.

9. The connector according to claim 6, wherein the grounding element is an integral stamped part.

10. The connector according to claim 1, wherein the insulation shell is an integrated injection molded part.

11. The connector according to claim 1, further comprising a shielding shell fitted on the insulation shell, the shielding shell has a front buckle engaging an elastic hook of the mating connector and a rear buckle engaging a locking protrusion of the mating connector.

12. The connector according to claim 11, wherein the shielding shell has a welding leg at a bottom of the insulation shell, the welding leg is inserted and welded into a socket on a circuit board.

13. An assembly, comprising:
a connector, including:
an insulation shell including a peripheral wall and a bottom wall enclosing an inner cavity, a retaining body is disposed in the inner cavity and connected to the bottom wall, the retaining body is in a middle region of the insulation shell and the insulation shell has a left region and a right region on a left side and a right side respectively of the retaining body;
a plurality of low-speed signal terminals respectively fixed to a front side and a rear side of the retaining body to electrically contact a plurality of low-speed mating signal terminals of a mating connector; and
a plurality of terminal modules installed in the insulation shell and each including a plurality of pairs of high-speed signal terminals, one of the terminal modules is installed in the left region and another of the terminal modules is installed in the right region.
a mating connector including a mating housing and a mating terminal module installed in the mating housing, the mating terminal module includes a mating insulator with a plurality of slots, a plurality of high-speed paired signal terminals set in the slots, and a conductive shield installed in the slots, the mating connector is matable with the connector and the mating terminal module mates with one of the terminal modules, a contact spring of one of the high-speed signal terminals electrically contacts one of the high-speed paired signal terminals and a grounding element of one of the terminal modules electrically contacts the conductive shield.

14. The assembly according to claim 13, wherein the mating housing has an outer peripheral wall enclosing a receiving cavity and a positioning column in the receiving cavity and connected to the outer peripheral wall, the positioning column mates with a positioning hole of the retaining body to guide the connector to mate with the mating connector.

15. The assembly according to claim 13, further comprising a plurality of low-speed paired signal terminals installed in the mating housing and electrically contacting the plurality of low-speed signal terminals of the connector.

16. The assembly according to claim 15, wherein the low-speed paired signal terminals are arranged in a pair of rows that each include a first low-speed paired signal terminal for electrostatic discharge protection and electrically contacting a first low-speed signal terminal of the plurality of low-speed signal terminals, and a second low-speed paired signal terminal with a function different from the first low-speed paired signal terminal, the second low-speed paired signal terminal electrically contacts a second low-speed paired signal terminal of the plurality of low-speed signal terminals of the connector.

17. The assembly according to claim 15, further comprising a plurality of low-speed signal cables respectively electrically connected to the low-speed paired signal terminals.

18. The assembly according to claim 17, further comprising a cable holder injection molded onto the low-speed signal cables and a plurality of high-speed signal cables of the mating connector.

19. The assembly according to claim 13, further comprising a locking component installed on the mating housing, the locking component includes:
an elastic hook that engages with a front buckle on a shielding shell of the connector; and
a locking protrusion that engages with a rear buckle of the shielding shell.

20. The assembly according to claim 19, wherein the elastic hook is movable between a locking position engaged with the front buckle and an unlocking position separated from the front buckle, the mating connector includes an unlocking strap connected to the locking component and driving the elastic hook to move between the locking position and the unlocking position.
